(19) United States
(12) Patent Application Publication
(10) Pub. No.: US 2015/0330648 A1
(43) Pub. Date: Nov. 19, 2015

(54) HVAC SYSTEM, AN HVAC CONTROLLER AND A METHOD OF HEATING AN LCD DISPLAY OF AN HVAC CONTROLLER

(71) Applicant: Lennox Industries Inc., Richardson, TX (US)

(72) Inventors: Darko Hadzidedic, Carrollton, TX (US); Joe Powell, Carrollton, TX (US); Sakthi Narayan Kumar Murugesan, Chennai (IN); Kevin M. Berger, Carrollton, TX (US)

(21) Appl. No.: 14/693,623

(22) Filed: Apr. 22, 2015

Related U.S. Application Data
(60) Provisional application No. 62/000,183, filed on May 19, 2014.

(51) Int. Cl. F24F 11/00; G05B 15/02

(52) U.S. Cl. CPC F24F 11/006; G05B 15/02

(57) ABSTRACT

An HVAC controller, a controller for a climate control system and a climate control system are disclosed herein. In one embodiment, the HVAC controller includes: (1) a display, (2) a display heater for the display and (3) a heater controller configured to operate the display heater based on ambient temperature and a supply voltage of the HVAC controller.

### CROSS-REFERENCE TO RELATED APPLICATION

This application claims the benefit of U.S. Provisional Application Ser. No. 62/000,183 filed by Hadzidedic on May 19, 2014, entitled “An HVAC System, an HVAC Controller and a Method Of Heating an LCD Display of an HVAC Controller,” commonly assigned with this application and incorporated herein by reference in its entirety.

### TECHNICAL FIELD

This application is directed, in general, to a heating, ventilation and air conditioning (HVAC) system and, more specifically, to a controller of an HVAC system.

### BACKGROUND

HVAC systems can be used to regulate the environment within an enclosed space. Typically, an air blower is used to pull air from the enclosed space into the HVAC system through ducts and push the air back into the enclosed space through additional ducts after conditioning the air (e.g., heating, cooling or dehumidifying the air). Various types of HVAC systems, including residential systems and commercial systems such as roof top units, may be used to provide conditioned air for enclosed spaces.

These so-called rooftop units, or RTUs, typically include one or more blowers, compressors and heat exchangers to heat and/or cool the building, and baffles to control the flow of air within the RTU. An RTU also includes a controller that directs the operation of the system. The controller and the other RTU equipment are usually located within a cabinet that limits the exposure to adverse environmental conditions. Though a cabinet provides some protection for the HVAC system, the equipment is still exposed to temperature extremes.

### SUMMARY

In one aspect, the disclosure provides an HVAC controller. In one embodiment, the HVAC controller includes: (1) a display, (2) a display heater for the display and (3) a heater controller configured to operate the display heater based on ambient temperature and a supply voltage of the HVAC controller.

In another aspect, the disclosure provides a controller for a climate control system. In one embodiment, the controller includes: (1) a display, (2) a display heater for the display and (3) a processor configured to operate the display heater by controlling a voltage supplied to the display heater based on an ambient temperature and a value of a supply voltage of the controller.

In yet another aspect the disclosure provides a climate control system. In one embodiment, the climate control system includes: (1) conditioning equipment for heating or cooling air in an enclosed space and (2) a system controller configured to direct the operation of the conditioning equipment, the controller having a display configured to provide a user interface for the climate control system, a display heater configured to generate heat for the display and a heater controller configured to operate the display heater based on an ambient temperature and a supply voltage of the system controller.

### BRIEF DESCRIPTION

Reference is now made to the following descriptions taken in conjunction with the accompanying drawings, in which:

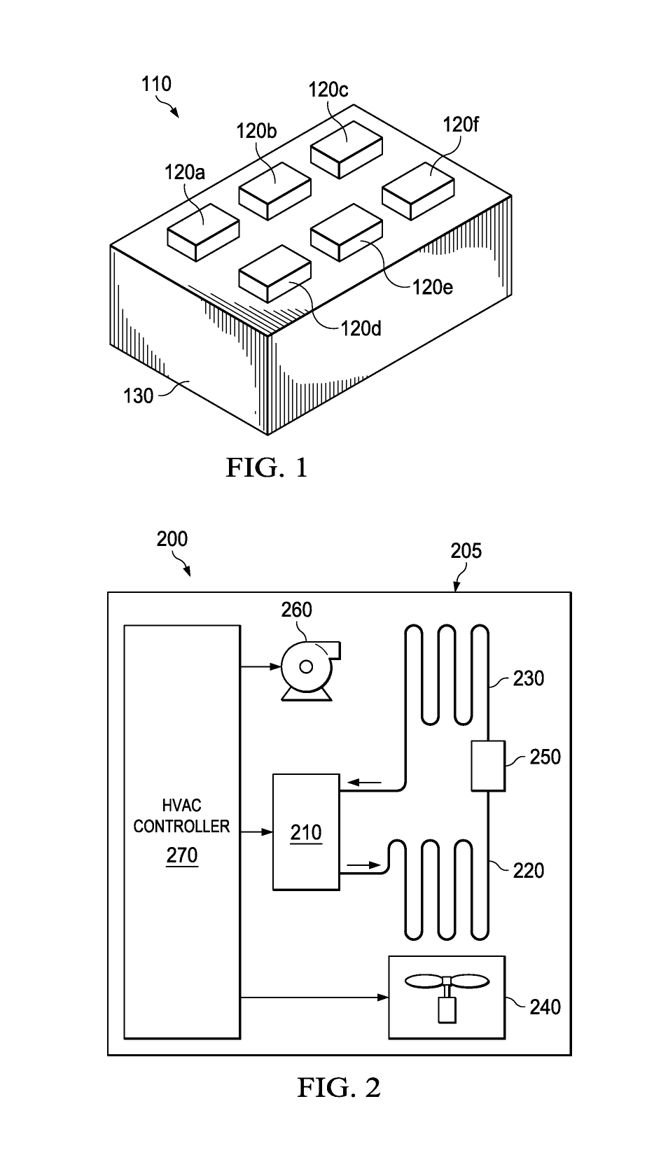

FIG. 1 illustrates a cluster of HVAC systems on a rooftop;

FIG. 2 illustrates a diagram of an embodiment of an HVAC system including an HVAC controller constructed according to the principles of the disclosure;

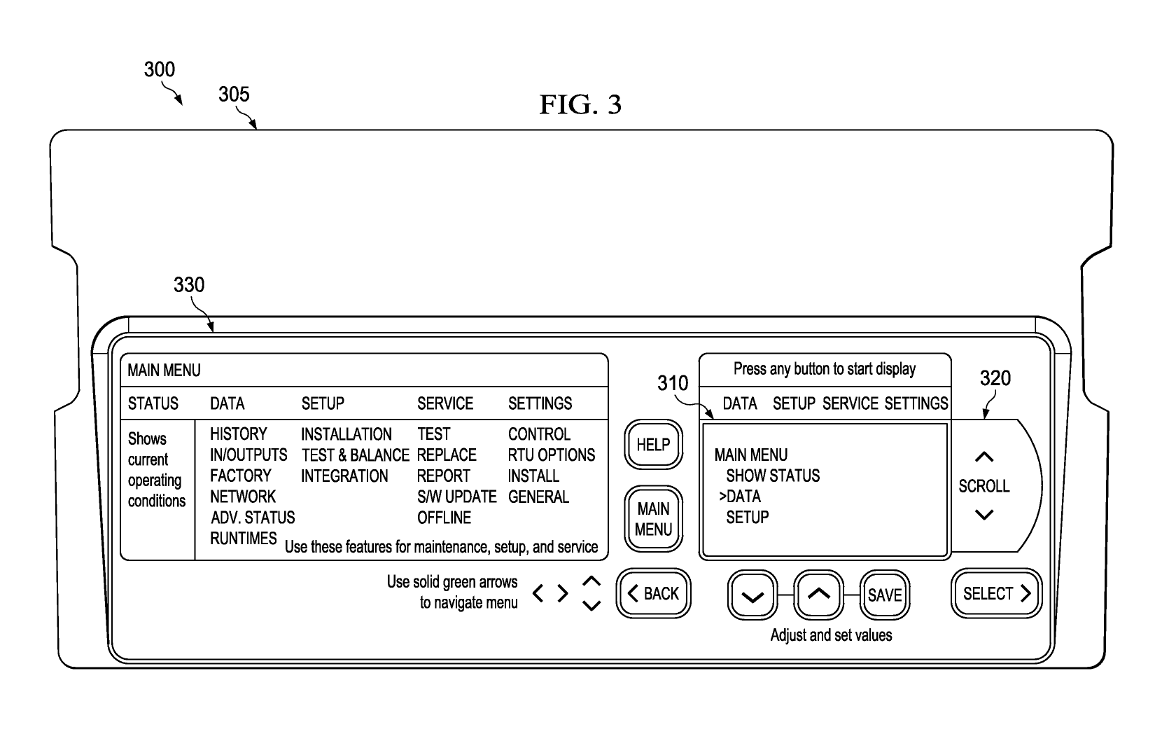

FIG. 3 illustrates a diagram of an embodiment of an HVAC controller including a display constructed according to the principles of the disclosure;

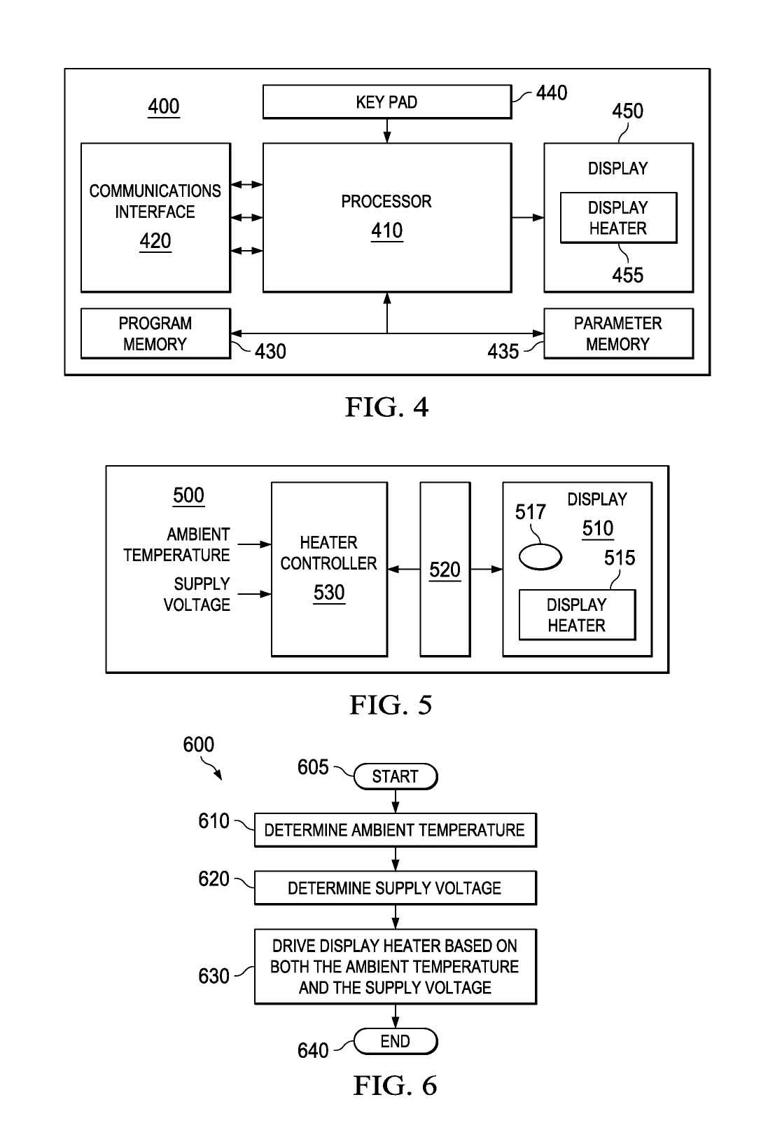

FIG. 4 illustrates a block diagram of an embodiment of an HVAC controller constructed according to the principles of the disclosure;

FIG. 5 illustrates another block diagram of an embodiment of a HVAC controller constructed according to the principles of the disclosure; and

FIG. 6 illustrates a flow diagram of an embodiment of a method of operating a display heater carried out according to the principles of the disclosure.

### DETAILED DESCRIPTION

The controllers for the RTUs often include a display that presents various menus, parameters, and other configuration information to a user. For example, an installer or technician can use the display when installing or servicing the RTU. A Liquid Crystal Display (LCD) is one type of display that can be used. An LCD provides a sophisticated visual interface for a user by presenting various menus, parameters, and other configuration information and responding to user inputs to navigate among the menus.

A LCD, however, has a limited temperature operating range that can be troublesome in the harsh operating conditions of a RTU. The low temperature operating range for an LCD is normally limited to minus twenty degrees Celsius. At temperatures less than minus twenty degrees Celsius, the liquid crystals of the LCD start to freeze. This freezing causes a slow response, dimming (loss of contrast) and eventually can result in an unreadable display.

To prevent freezing, some LCD models include a heater that is either turned on or off when compared to a set ambient temperature. Thus, the LCD heater is turned on when the ambient temperature is below a freezing threshold and is then turned off when the ambient temperature rises above the freezing threshold. While this method can prevent freezing of the LCD, simply turning on and off the heater can also reduce the life of the heater due to unnecessarily large power dissipation when the ambient temperature is slightly below the freezing threshold. Since the heaters are operated at the supply voltage of the HVAC controller, the impact on the life of the heater can vary due to the wide input voltage range that is used in different HVAC systems, e.g., 18-30 VAC. The unnecessary use of the heater can also cause “browning” that impacts the readability of the LCD.

It is realized herein that the life of the heater and LCD display can be preserved by managing the power supplied to the heater. It is further realized herein that the amount of power used to operate the heater can be reduced by employing the power management control scheme disclosed herein. As such, a controller for climate control systems, such as HVAC systems, is disclosed that are operable in extreme cold environments and includes a sophisticated display, such as an LCD, a display heater and a heater controller that preserves the life of the display heater and the readability of the display. In at least one embodiment, the heater controller is configured to operate the display heater based on both the ambient temperature and the supply voltage of the HVAC controller. The HVAC controller disclosed herein can be used in a RTU but the disclosure is not limited thereto. For example, the HVAC systems disclosed herein can be commercial or residential, located on a rooftop or at ground level. In addition to being used outside where temperatures can reach below freezing in some locations, the disclosed controller can also be used inside in a freezer or other cold environments where an LCD can freeze. Thus, the disclosed controller can be used, for example, in HVAC systems and other climate control systems such as refrigeration or freezer systems. FIG. 1 provides an example of HVAC systems that are RTUs.

FIG. 1 illustrates a diagram of a cluster 110 of HVAC systems 120a-120f constructed according to the principles of the disclosure. The HVAC systems 120a-120f are located on a rooftop of a building 130 and therefore are exposed to the ambient temperature. The HVAC systems 120a-120f are configured to condition the air in the interior space of the building 130 and may be managed via a centralized management system operated by an owner or lessee of the building 130. For example, the building 130 may be one of many retail stores operated by a national chain. FIG. 2 provides more detail of the HVAC systems 120a-120f. The HVAC systems 120a-120f include the necessary conditioning equipment such as compressors and heat exchangers to heat and/or cool the building 130.

FIG. 2 illustrates a diagram of an embodiment of an HVAC system 200 constructed according to the principles of the disclosure. The HVAC system 200 may be one of the HVAC systems 120a-120f illustrated in FIG. 1. While FIG. 2 includes some of the internal aspects of the HVAC system 200, one skilled in the art will know that the HVAC system 200 includes additional components. The HVAC system 200 includes an enclosure 205 for containing various components of the HVAC system 200. The HVAC system 200 includes a compressor 210, a condenser coil 220 and an evaporator coil 230. The operation of the HVAC system 200 is described without limitation in the context of cooling air in an interior space of the building 130. The compressor 210 compresses a refrigerant that flows to the condenser coil 220 over which a fan 240 moves air to transfer heat to the ambient environment. The refrigerant flows through an expansion valve 250, cools and flows through the evaporator coil 230. Air from an interior space being conditioned by the HVAC system 200 is cooled as it is moved past the evaporator coil 230 by a blower 260. The operation of the various components of the HVAC system 200 is controlled at least in part by an HVAC controller 270. The HVAC system 200 is an integrated HVAC system, including both the condenser coil 220 and the evaporator coil 230 within the enclosure 205. Other HVAC systems are also within the scope of the disclosure, including indoor units, outdoor units, attic units, and heat pumps.

In one embodiment, the HVAC system 200 is constructed by a manufacture. This includes placing the compressor 210, the condenser coil 220, the evaporator coil 230, the fan 240, the expansion valve 250, the blower 260 and the HVAC controller 270 within the enclosure 205. The HVAC controller 270 is configured to operate as described below with respect to FIGS. 3-6.

FIG. 3 illustrates a diagram of an embodiment of an HVAC controller 300 constructed according to the principles of the disclosure. The HVAC controller 300 can be the HVAC controller 270 of FIG. 2. The HVAC controller 300 includes a cover 305, a display 310 and an input keypad 320. The HVAC controller 300 includes additional components that are not illustrated, including some components that are located under the cover 305 and are not visible in FIG. 3. Such components include a display heater and a heater controller. The display 310 is a sophisticated display that is configured to present various menus, parameters, and other configuration information to a user. In one embodiment the display 310 is an LCD.

The keypad 320 is configured to accept user input to make selections presented to the user by the display 310, navigate among menus, and input configuration parameters. The keypad 320 includes multiple buttons or switches that are located around the display 310. The buttons include “Help,” “Main Menu,” up and down arrows, etc. The HVAC controller 300 advantageously includes a menu map 330 for reference by the user when interacting with the HVAC controller 300.

Turning to FIG. 4, illustrated is a block diagram of an embodiment of an HVAC controller 400 constructed according to the principles of the disclosure. The HVAC controller 400 is illustrated without limitation. The HVAC controller 400 includes a processor 410, a communications interface 420, a program memory 430, a parameter memory 435, a keypad 440 and a display 450.

The processor 410 accepts inputs from the keypad 440 and provides output data to the display 450. The processor 410 can be any conventional or future developed microcontroller, microprocessor or state machine. The processor 410 operates in response to program instructions read from the memory 430 to control aspects of the operation of an HVAC system, such as the HVAC system 200. The program instructions can be “firmware.” The memory 430 can be a conventional memory and may include both nonvolatile memory for persistent storage of program instructions and volatile memory for temporary storage of data. The memory 430 may also include rewritable memory, e.g., flash memory, to allow for updating of the program instructions.

The parameter memory 435 is a conventional parameter memory that is used to store parameters associated with operation of the HVAC system. Parameters may include, e.g., hardware configuration settings, component serial numbers, installed options, hardware revisions, control algorithm coefficients, operational data, diagnostics, service history, temperature set points and setback times. The parameter memory 430 may be volatile or nonvolatile, though in various embodiments nonvolatile memory, e.g. flash memory, may be preferred to retain stored parameters if power to the HVAC system is interrupted.

The processor 410 interacts with other components of the HVAC system via the communications interface 420. As such, the communications interface 420 can include a system interface that includes the necessary electronic components to address various components of the HVAC system, and to provide control signals at appropriate voltage levels. The communications interface 420 may also be configured to provide an interface to a network, e.g., a local area network (LAN) or the internet. Thus, the communications interface 420 can includes a network interface that allows monitoring of various operational aspects of the HVAC system, such as operational status, and power consumption. The communications interface 420 can also provide a means to couple a computer to the HVAC controller 400. As such, the communications interface 420 can include a computer interface that is conventionally used to configure the HVAC system during, for example, the manufacturing process and communicate with the controller when servicing. The processor 410 can receive the ambient temperature via the communications interface such as from a systems interface or network interface. As such, the ambient temperature can be received from an external source such as a weather website or weather service.

The display 450 provides a visual interface for a user. The display 450 can be the display 410 of FIG. 4. As such, the display 450 can be an LCD. The display 450 includes a display heater 455 that is configured to prevent the display 450 from freezing. In some embodiments, the display 450 and display heater 455 can be conventional components. Not illustrated in FIG. 4 is a heater controller for the display heater 455. The heater controller can be implemented in the processor 410. In some embodiments, a portion of the heater controller can also be stored as a series of operating instructions on the program memory 430. Data, such as empirical data, employed by the heater controller can also be stored and accessed. For example, Table 1 below can be stored as a look-up table in the program memory 430. The heater controller is discussed below is discussed with respect to FIG. 5.

FIG. 5 illustrates a block diagram of an embodiment of an HVAC controller 500 having a display 510, a display heater 515, a dedicated temperature sensor 517 and a heater controller 530. The HVAC controller 500 is a rugged controller that is designed to be employed in below freezing environments. For example, the HVAC controller 500 can be employed in the HVAC systems of FIG. 1. One skilled in the art will understand that the HVAC controller 500 can include additional components that are not illustrated but are typically included in conventional HVAC controllers; some of which are described above with respect to FIGS. 2, 3 and 4.

The display 510 is an LCD that is configured to present various menus, parameters, and other configuration information to a user. Since the display 510 is an LCD, the display 510 is susceptible to freezing at temperatures below minus twenty degrees Celsius. To prevent freezing of the display 510, the display 510 includes the display heater 515.

The display heater 515 is a heating circuit that generates heat for the display when activated, i.e., turned on. The display heater 515 can be a transparent heater that is positioned with the LCD, i.e., aligned with a display glass of the display 510. In one embodiment, the display heater 515 is a conventional foil heater that is positioned across the display 510. The display heater 515 is operated, i.e., turned on or off, via a switch 520 that is controlled by the heater controller 530. In one embodiment, the heater controller 530 can control the switch 520 according to a duty cycle. The switch can be a conventional on/off switch that is employable in a controller. Turning back to FIG. 4, the switch 520 can be an internal switch of the processor 410. In another embodiment, the switch 520 can be external to the processor 410.

The heater controller 530 is configured to operate the display heater 515 based on ambient temperature and supply voltage of the HVAC controller 500. As such, instead of simply turning the heater circuit on when dropping below a freezing threshold for the LCD and then turning it off when the ambient temperature rises above the threshold, the heater controller 530 intelligently operates the display heater 515 to provide sufficient heat to prevent freezing of the LCD based on the supply voltage and the ambient temperature. Accordingly, the overall power dissipation of the HVAC controller 500 can be reduced compared to a simple on/off control using only the ambient temperature.

In one embodiment, the heater controller 530 is configured to pulse modulate the display heater 515 based on the ambient temperature and voltage. The heater controller 530 is configured to determine the appropriate duty cycle for operating the display heater 515 in order to provide enough power to prevent liquid crystal freezing and increase the response and readability of the display 510. In one embodiment, the heater controller 530 employs empirical data to control operation of the display heater 515. The empirical data can be stored in a table such as Table 1 provided below. Table 1 shows the various heater duty cycles based on the measured ambient temperature and different voltage values of a supply voltage.

TABLE 1
Duty Cycle for Heater Controller With Respect To
Ambient Temperature and Supply Voltage

| | Supply voltage | | | |
|---|---|---|---|---|
| Ambient Temp | <24 VAC | 24-26 VAC | 26-28 VAC | >28 VAC |
| −15 C. to −20 C. | 30% | 25% | 20% | 20% |
| −20 C. to −25 C. | 45% | 40% | 35% | 30% |
| −25 C. to −30 C. | 75% | 60% | 55% | 50% |
| −30 C. to −35 C. | 100% | 80% | 70% | 60% |
| −35 C. to −40 C. | 100% | 100% | 90% | 80% |
| Below −40 C. | 100% | 100% | 100% | 100% |

In some embodiments, the heater controller 530 is configured to calculate the duty cycle for the display heater 515 instead of using a look-up table. The heater controller 530 can employ an equation based on historical data to calculate the duty cycle. In one embodiment, the equation can represent the data from Table 1. By calculating the duty cycle, storage space and memory access can be reduced.

The heater controller 530 is configured to receive the ambient temperature and the supply voltage and use this information to determine the duty cycle for the display heater 515. The ambient temperature and supply voltage can be used with the look-up table such as Table 1 or in an equation to calculate the needed duty cycle. In some embodiments, the ambient temperature is received from the HVAC system as part of the normal operation of the system. Thus, the heater controller 530 simply employs existing data that is already obtained. In other embodiments, a dedicated temperature sensor 517 can be installed proximate the LCD glass to provide the ambient temperature for the heater controller 530. The temperature sensor 517 can be a conventional sensor. This provides tighter control of the heating requirements for the display 510. Employing the dedicated temperature sensor can also provide further optimization of the power consumption and life extension of the display heater 515 and display 510.

FIG. 6 illustrates a flow diagram of a method 600 of operating a display heater for an HVAC controller carried out according to the principles of the disclosure. The HVAC controller can direct the operation of an HVAC system that is located outside. The method may be carried out be a heater controller as disclosed herein. The method 600 begins in a step 605.

In a step 610, the ambient temperature is determined. The ambient temperature can be received or sensed. In one embodiment, the ambient temperature can be determined by a dedicated temperature sensor. In another embodiment, the ambient temperature can be conventionally obtained from the HVAC system.

In a step 620, a supply voltage is determined. In one embodiment, the supply voltage can be the supply voltage of the HVAC controller and can be determined based on the model, such as a model number, or type of the controller. In another embodiment, the supply voltage can be sensed.

In a step 630, a display heater is driven based on both the supply voltage and the ambient temperature. In one embodiment, the duty cycle is controlled based on the supply voltage and the ambient temperature. In another embodiment, the amount of voltage supplied to the display heater is modified based on the supply voltage and ambient temperature. For example, a resistor can be used to step down the amount of voltage supplied to the display heater. In yet another embodiment, both the duty cycle and the amount of voltage supplied to the display heater can be controlled based on both the ambient temperature and the supply voltage. The method 600 ends in a step 640.

At least a portion of the above-described apparatuses and methods may be embodied in or performed by various conventional digital data processors, microprocessors or computing devices, wherein these devices are programmed or store executable programs of sequences of software instructions to perform one or more of the steps of the methods, e.g., steps of the method of FIG. 6. The software instructions of such programs may be encoded in machine-executable form on conventional digital data storage media that is non-transitory, e.g., magnetic or optical disks, random-access memory (RAM), magnetic hard disks, flash memories, and/or read-only memory (ROM), to enable various types of digital data processors or computing devices to perform one, multiple or all of the steps of one or more of the above-described methods, e.g., one or more of the steps of the method of FIG. 6. Additionally, an apparatus, such as an HVAC controller, may be designed to include the necessary circuitry or programming to perform each step of a method of disclosed herein.

Portions of disclosed embodiments may relate to computer storage products with a non-transitory computer-readable medium that have program code thereon for performing various computer-implemented operations that embody a part of an apparatus, system, or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter.

Those skilled in the art to which this application relates will appreciate that other and further additions, deletions, substitutions and modifications may be made to the described embodiments.

What is claimed:

1. A heating, ventilation and air conditioning (HVAC) controller, comprising:
a display;
a display heater for said display; and
a heater controller configured to operate said display heater based on ambient temperature and a supply voltage of said HVAC controller.

2. The HVAC controller as recited in claim 1 further comprising a switch configured to turn on and turn off said display heater, wherein operation of said switch is controlled by said heater controller.

3. The HVAC controller as recited in claim 1 wherein said heater controller is configured to determine a duty cycle for operating said display heater based on said ambient temperature and said supply voltage.

4. The HVAC controller as recited in claim 1 wherein said heater controller is configured to determine said duty cycle based on stored empirical data.

5. The HVAC controller as recited in claim 1 wherein said heater controller is configured to calculate said duty cycle based on historical data.

6. The HVAC controller as recited in claim 1 further comprising a temperature sensor located proximate said display, wherein said heater controller is configured to receive said ambient temperature from said temperature sensor.

7. The HVAC controller as recited in claim 1 wherein said heater controller is configured to modify an amount of voltage supplied to said display heater based on said ambient temperature and said supply voltage.

8. The HVAC controller as recited in claim 1 wherein said heater controller is configured to operate said display heater by controlling both a duty cycle of a voltage supplied to said display heater and an amount of said voltage supplied to said display based on said ambient temperature and said supply voltage of said HVAC controller.

9. The HVAC controller as recited in claim 1 wherein said supply voltage is determined from a model of said HVAC controller.

10. A controller for a climate control system, comprising:
a display;
a display heater for said display; and
a processor configured to operate said display heater by controlling a voltage supplied to said display heater based on an ambient temperature and a value of a supply voltage of said controller.

11. The controller as recited in claim 10 wherein said display is a liquid crystal display.

12. The controller as recited in claim 10 further comprising a memory having a data table including duty cycles for various values of said supply voltage and ambient temperatures, wherein said processor is configured to employ said data table to operate said display heater.

13. The controller as recited in claim 10 further comprising a communications interface coupled to said processor, wherein said processor is configured to receive said ambient temperature via said communications interface.

14. The controller as recited in claim 10 wherein said processor is configured determine a value or a duty cycle for said voltage supplied to said display heater based on said ambient temperature and said value of a supply voltage of said controller.

15. The controller as recited in claim 10 wherein said processor is configured determine both a value and a duty cycle for said voltage supplied to said display heater based on said ambient temperature and said value of a supply voltage of said controller.

16. A climate control system, comprising:
conditioning equipment for heating or cooling air in an enclosed space; and
a system controller configured to direct the operation of said conditioning equipment, said system controller including:
a display configured to provide a user interface for said climate control system;
a display heater configured to generate heat for said display; and
a heater controller configured to operate said display heater based on an ambient temperature and a supply voltage of said system controller.

17. The climate control system as recited in claim 16 wherein said heater controller is configured to operate said display heater by increasing and reducing a voltage value of said supply voltage based on said ambient temperature and said supply voltage.

18. The climate control system as recited in claim 16 further comprising a switch, wherein said heater controller is configured to determine a duty cycle based on said ambient temperature and said supply voltage and operate said display heater by controlling said switch according to said duty cycle.

19. The climate control system as recited in claim 16 wherein said display heater generates said heat from a voltage controlled by said heater controller according to said ambient temperature and said supply voltage.

20. The climate control system as recited in claim 16 wherein said heater controller receives said ambient temperature via a communications interface of said system controller.
